(19) United States
(12) Patent Application Publication
(10) Pub. No.: US 2006/0106776 A1
(43) Pub. Date: May 18, 2006

(54) Utilizing mathematical operations with abstract queries

(75) Inventors: Richard D. Dettinger, Rochester, MN (US); Daniel P. Kolz, Rochester, MN (US); Shannon E. Wenzel, Colby, WI (US)

Correspondence Address: William J. McGinnis;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/992,398

(22) Filed: Nov. 18, 2004

(51) Int. Cl. G06F 17/30

(52) U.S. Cl. 707/3

(57) ABSTRACT

Methods, systems, and articles of manufacture are provided for composing abstract queries by referencing previously defined abstract queries and combining the queries based on mathematic operations, referred to as “query math”. Composing queries by performing query math, such as addition and subtraction, with whole abstract queries facilitates and encourages reuse of existing abstract queries.

### CROSS-REFERENCE TO RELATED APPLICATIONS

The present application is related to the following commonly owned, co-pending applications: U.S. patent application Ser. No. 10/083,075, filed Feb. 26, 2002, entitled “Application Portability And Extensibility Through Database Schema And Query Abstraction” and U.S. patent application Ser. No. 10/403,356, filed Mar. 31, 2003, entitled “Dealing With Composite Data Through Data Model Entities”, which are hereby incorporated herein in their entirety.

### BACKGROUND OF THE INVENTION

1. Field of the Invention

The present invention generally relates to data processing and more particularly to performing mathematical operations with previously defined abstract queries to create new abstract queries.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, in a DBMS, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL) and application programming interfaces (API's) such as Java® Database Connectivity (JDBC). The term “query” denominates a set of commands for retrieving data from a stored database. Queries take the form of a command language, such as SQL, that lets programmers and programs select, insert, update, find out the location of data, and so forth.

Unfortunately, generating queries using SQL may require a detailed understanding of the possibly complex physical layout of the underlying database and interpretation of cryptic field names. For some applications, to facilitate the query building process, an abstraction model may be utilized that, in effect, hides some of the complexities of the underlying database physical layout from users. The abstraction model may include logical fields with recognizable names that map to corresponding physical fields of the underlying database. “Abstract” queries may be generated containing conditions based on the logical fields. Upon issuance, the logical fields of an abstract query may be mapped to corresponding physical fields to create a physical or “concrete” query. For some applications, abstract queries may be saved, allowing subsequent users to reuse the saved abstract queries without having to generate their own. The concepts of data abstraction and abstract queries are described in detail in the commonly owned, co-pending application Ser. No. 10/083,075, entitled “Improved Application Portability And Extensibility Through Database Schema And Query Abstraction,” filed Feb. 26, 2002, herein incorporated by reference in its entirety.

Data abstraction models (DAMs) and abstract queries have made it much easier for users to access and analyze data within databases. Substantial effort has been put towards building and implementing interfaces and query building applications that are designed to build abstract queries. In some cases, while performing data analysis, a user may identify a particular abstract query that presents a certain perspective of data that is of interest. If the user wants to get a slightly altered perspective of the same data, the user could (and typically does) create a new abstract query by taking the identified abstract query's syntax and modifying it slightly, according to the desired perspective, and then creates a new query based on the modified syntax. Additionally, a user may identify two or more abstract queries that, when combined, provide the desired perspective of data that is of interest. In this case, the user may combine the syntax of the two or more identified queries to produce a new abstract query. The creation of new abstract queries in the manner described above is very common. However, a large number of very similar queries add to the difficulty in locating the desired query, thereby inhibiting functionality and ease of use of the system.

Therefore, it would be advantageous for users to have the ability to combine existing abstract queries in a manner that is intuitive for users such as data analysts and researchers. Additionally, there is a need to maximize the reuse of existing abstract queries without requiring users to create and save new abstract queries.

### SUMMARY OF THE INVENTION

The present invention is generally directed to methods, systems and articles of manufacture for combining abstract queries by utilizing mathematical operations. These mathematical operations, referred to herein as “query math”, may be performed to combine multiple abstract queries, with the result being a combined abstract query.

One embodiment of the present invention provides a computer-implemented method for querying data. The computer-implemented method generally includes providing a first query and a second query, receiving a selection of a mathematical operator selected from one of (i) an addition operator configured to perform addition of the first and second queries; and (ii) a subtraction operator configured to perform subtraction of the first and second queries, and operating on the first and second queries according to the selected mathematical operator to generate a resultant query, wherein operating comprises one of: adding selected fields of the first and second queries to the resultant query if the selected mathematical operator is the addition operator, and omitting selected fields of the first and second queries from the resultant query if the selected mathematical operator is the subtraction operator.

Another embodiment of the present invention provides a method of mathematically operating on queries in a graphical user interface environment. The method generally includes providing a graphical interface comprising a query list for displaying representations of a plurality of queries, a first window for displaying a syntax of a first query selected from the query list, a second window for displaying a syntax of a second query selected from the query list, an operator selection element displayed on the pallete and allowing selection of a mathematical operator from at least two available mathematical operators for mathematically relating at least two queries selected from the query list, wherein the at least two available mathematical operators comprise an addition operator and a subtraction operator. The method also includes a button for initiating a process of mathematically operating on the first and second queries according to the selected mathematical operator to produce a resultant query, wherein the process comprises, and adding selected fields of the first and second queries to the resultant query if the selected mathematical operator is the addition operator; and omitting selected fields of the first and second queries from the resultant query if the selected mathematical operator is the subtraction operator.

Another embodiment of the present invention provides a computer-readable medium containing a program which, when executed, performs operations for combining abstract queries from within an application. The operations generally include providing a first query and a second query, receiving a selection of a mathematical operator selected from one of (i) an addition operator configured to perform addition of the queries; and (ii) a subtraction operator configured to perform subtraction of the queries, and operating on the first and second queries according to the selected mathematical operator to generate a resultant query, wherein operating comprises one of: adding selected fields of the first and second queries to the resultant query if the selected mathematical operator is the addition operator, and omitting selected fields of the first and second queries from the resultant query if the selected mathematical operator is the subtraction operator.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a relational view of software and hardware components of one embodiment of the invention.

FIG. 2 illustrates an abstract query and corresponding data repository abstraction component, according to one embodiment of the invention.

FIG. 3 is a flow chart illustrating the operation of a runtime component, according to one embodiment of the invention.

FIG. 4 is a flow chart further illustrating the operation of a runtime component, according to one embodiment of the invention.

FIG. 5 is a flow chart illustrating the high-level processing steps related to combining abstract queries according to the query math access method.

FIG. 6 is a flow chart that describes the process of combining abstract queries using the addition query math operation.

FIG. 7 is a flow chart that describes the process of combining abstract queries using the subtraction query math operation.

FIGS. 8-9 illustrate exemplary GUI screens directed to combining abstract queries using query math operations.

### DETAILED DESCRIPTION OF THE PREFERRED EMBODIMENTS

The present invention is generally directed to methods, systems, and articles of manufacture for composing abstract queries by referencing previously defined abstract queries and combining the queries based on mathematic operations, referred to herein as “query math”. In one aspect of composing queries by performing mathematical operations, such as addition and subtraction, with whole abstract queries is facilitated by reuse of existing abstract queries stored in persistent storage.

Further, in the following, reference is made to embodiments of the invention. The invention is not, however, limited to specific described embodiments. Instead, any combination of the following features and elements, whether related to different embodiments or not, is contemplated to implement and practice the invention. Furthermore, in various embodiments the invention provides numerous advantages over the prior art. Although embodiments of the invention may achieve advantages over other possible solutions or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in the claims. Similarly, reference to “the invention” shall not be construed as a generalization of any inventive subject matter disclosed herein and shall not be considered to be an element or limitation of the appended claims, except where explicitly recited in a specific claim.

As used herein, the term user may generally apply to any entity utilizing the data processing system described herein, such as a person (e.g., an individual) interacting with an application program or an application program itself, for example, performing automated tasks. While the following description may often refer to a graphical user interface (GUI) intended to present information to and receive information from a person, it should be understood that in many cases, the same functionality may be provided through a non-graphical user interface, such as a command line and, further, similar information may be exchanged with a non-person user via a programming interface.

As used herein, the term database generally refers to a collection of data arranged for ease and speed of search and retrieval. While the following description focuses on transaction statements (such as queries) for relational databases, those skilled in the art will recognize the methods described herein may be used with any type of database including an object-relational database and an XML-based database.

In one embodiment of a data abstraction model, users may compose an abstract query using a set of logical fields defined by a data abstraction layer. The data abstraction layer, along with an abstract query interface, provide users with an abstract view of the data available to query (e.g., search, select, and modify). The data itself is stored in a set of underlying physical databases using a concrete physical representation (e.g., a relational database). The physical representation may include a single computer system, or may comprise many such systems accessible over computer networks. The data abstraction layer provides a logical view of one or more such underlying data repositories that is independent of the particular manner of data representation. Where multiple data sources are provided, each logical field may be is configured to include a location specification identifying the location of the data to be accessed. A runtime component is configured to resolve an abstract query into a form that can be issued against the underlying physical data repositories.

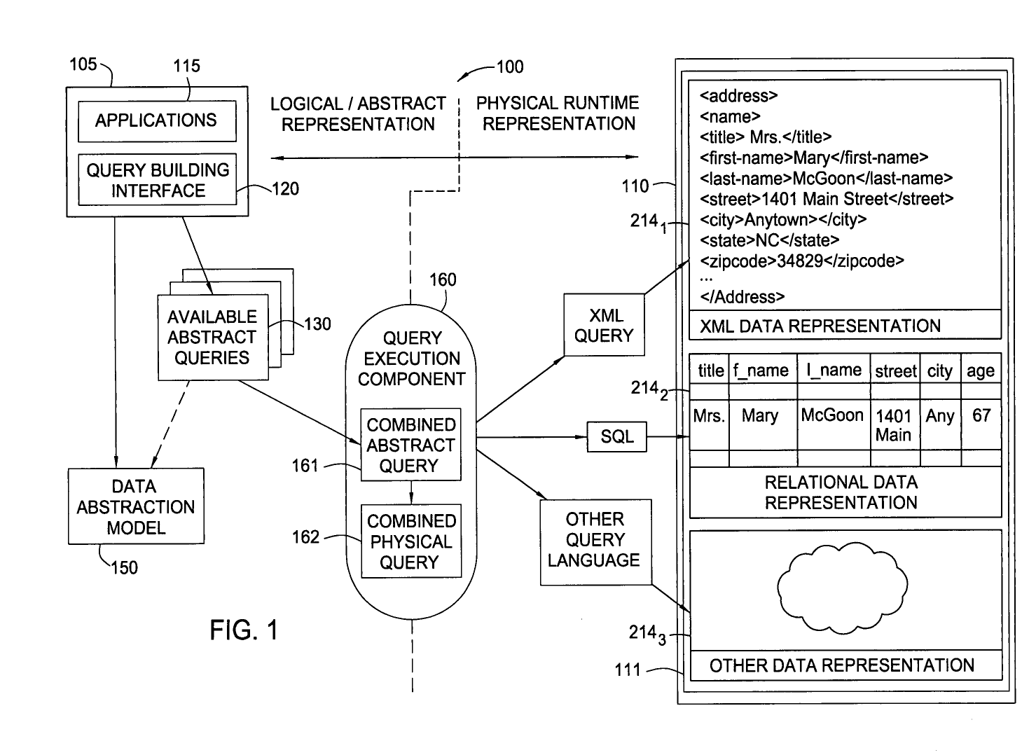

One embodiment of the invention is implemented as a program product for use with a computer system such as, for example, the computer system 100 shown in FIG. 1 and described below. The program product defines functions of the embodiments (including the methods) described herein and can be contained on a variety of signal-bearing media. Illustrative signal-bearing media include, without limitation, (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed across communications media, (e.g., a computer or telephone network) including wireless communications. The latter embodiment specifically includes information downloaded from the internet and other networks. Such signal-bearing media, when carrying computer-readable instructions that perform methods of the present invention, represent embodiments of the present invention.

In general, the routines executed to implement the embodiments of the invention, may be part of an operating system or a specific application, component, program, module, object, or sequence of instructions. The software of the present invention typically is comprised of a plurality of instructions capable of being performed using a computer system. Also, programs typically also include variables and data structures that reside in memory or on storage devices as part of their operation. In addition, various programs described hereinafter may be identified based upon the application for which they are implemented in a specific embodiment of the invention. Those skilled in the art will recognize, however, that any particular nomenclature that follows is used merely for convenience, and thus does not limit the invention for use solely in any specific application identified or implied by such nomenclature. Furthermore, the functionality of programs described herein uses discrete modules or components interacting with one another. Those skilled in the art will recognize that different embodiments may combine or merge the components and modules described herein in many different ways.

### An Exemplary System

FIG. 1 illustrates a relational view of hardware and software components of a data processing system 100 in accordance with one embodiment of the invention. The system 100 illustratively includes a client computer system 105 comprising a variety of applications including a query building interface 120 for accessing data in a database 111, via a database management system (DBMS) 110. As illustrated, the database 111 may accommodate data in a variety of different physical representations 214, such as an extensible markup language (XML) representation 214₁, a relational representation 214₂, or some other data representation 214₃.

The system 100 may include a data abstraction model (DAM) 150 that, in effect, shields a user from the details of the particular physical representation of the database 111. The DAM 150, also referred to as a data repository abstraction (DRA) in related applications, may define a set of logical fields that map to underlying physical fields of the underlying database 111. Users are able to create abstract queries based on the logical fields, via the query building interface 120. Upon issuance of abstract queries, a query execution component 160 may convert an abstract query into a physical or “concrete” query suitable for issuance against the database 111 by mapping logical fields of the abstract query to physical fields of the particular physical representation 214, based on the field definitions in the DAM 150. The mapping of abstract queries to physical queries, by the query execution component 150, is described in detail in the previously referenced U.S. patent application Ser. No. 10/083,075.

Embodiments of the present invention facilitate the use of previously defined abstract queries, referred to herein as available abstract queries 130. Specifically, embodiments of the present invention allow users to form new abstract queries by combining two or more available abstract queries 130. However, rather than combining individual components of queries, entire available queries 130 are combined by employing mathematical operations, such as addition and subtraction, to create combined abstract queries 161. For example, two queries can be added together to yield a third query, and one query can be subtracted from another to yield a third query. Once the combined abstract query 161 is created, the query execution component generates a corresponding combined physical query 162 by referencing the data abstraction model 150.

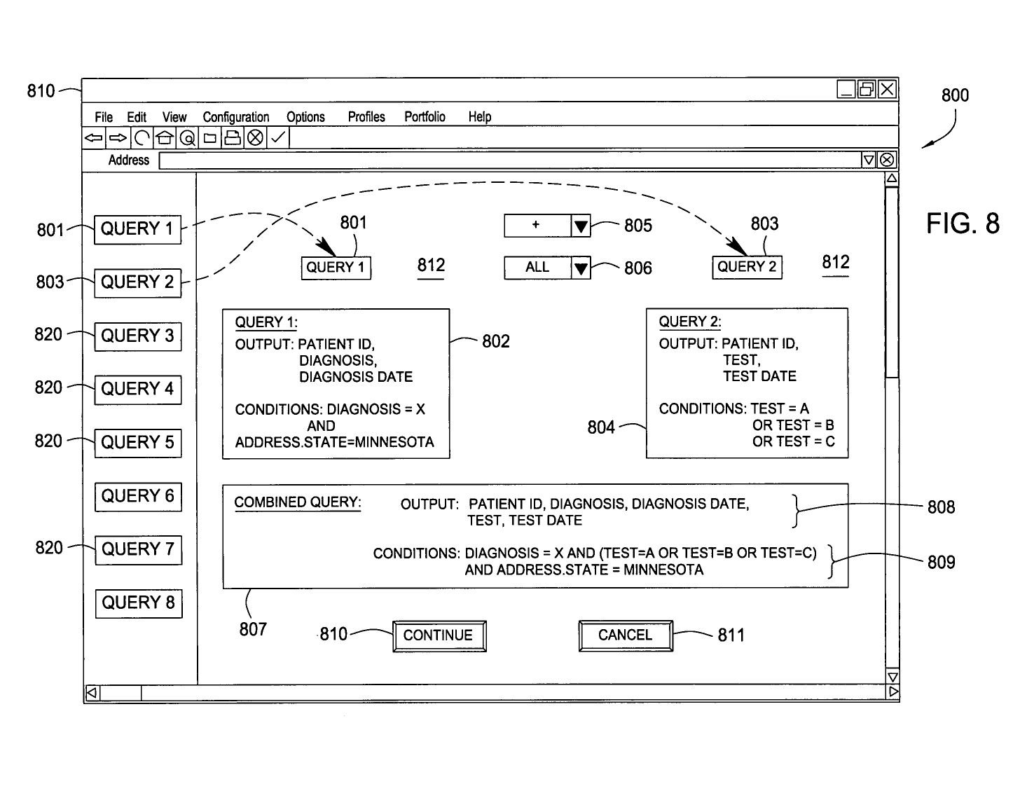

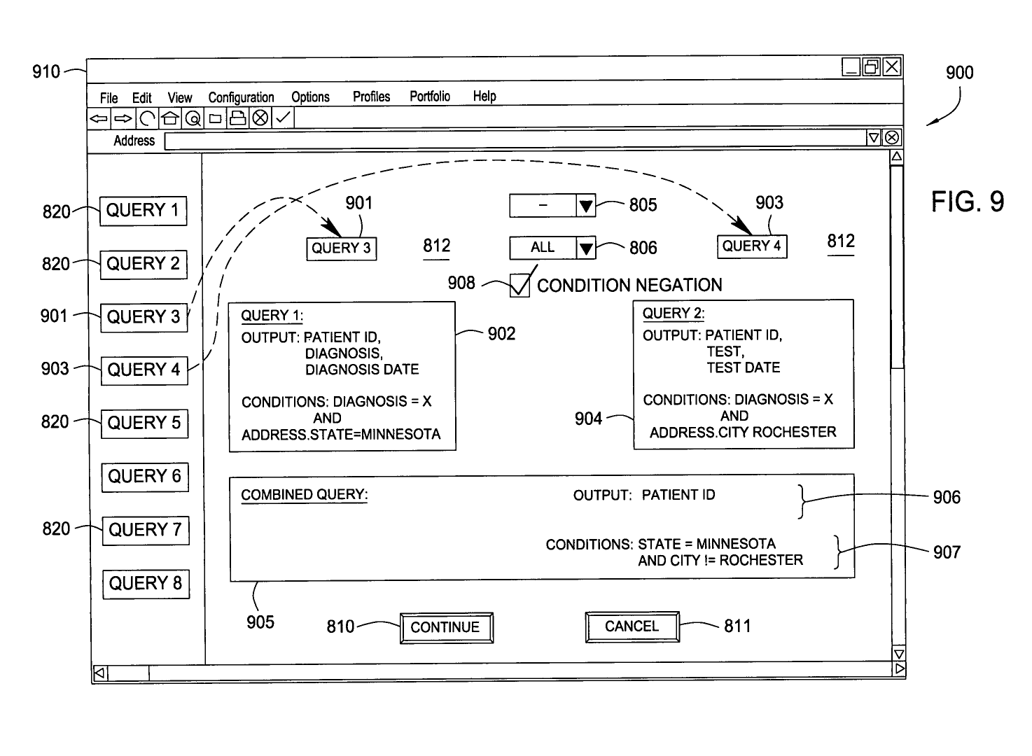

It should be noted that the combined abstract query 161 need not be stored permanently in the system 100. Rather, the combined abstract query 161 may be maintained by the query building interface 120 (or some other application 115) for the duration of a user's query building session. Handling the combined abstract query 161 in this manner allows for avoiding the storing and management of combined abstract queries 161 that are very similar to previously defined available abstract queries 130. This minimizes redundancies and maximizes reuse of the available abstract queries 130. However, if the user decides that the newly created combined abstract query 130 should, in fact, be stored so that it can be referred to in future query building sessions, the user can specify that the particular combined abstract query 161 be permanently saved by making certain selections via the query building interface 120. Creation and management of the combined abstract queries 161 will be described in more detail with reference to FIGS. 8 and 9.

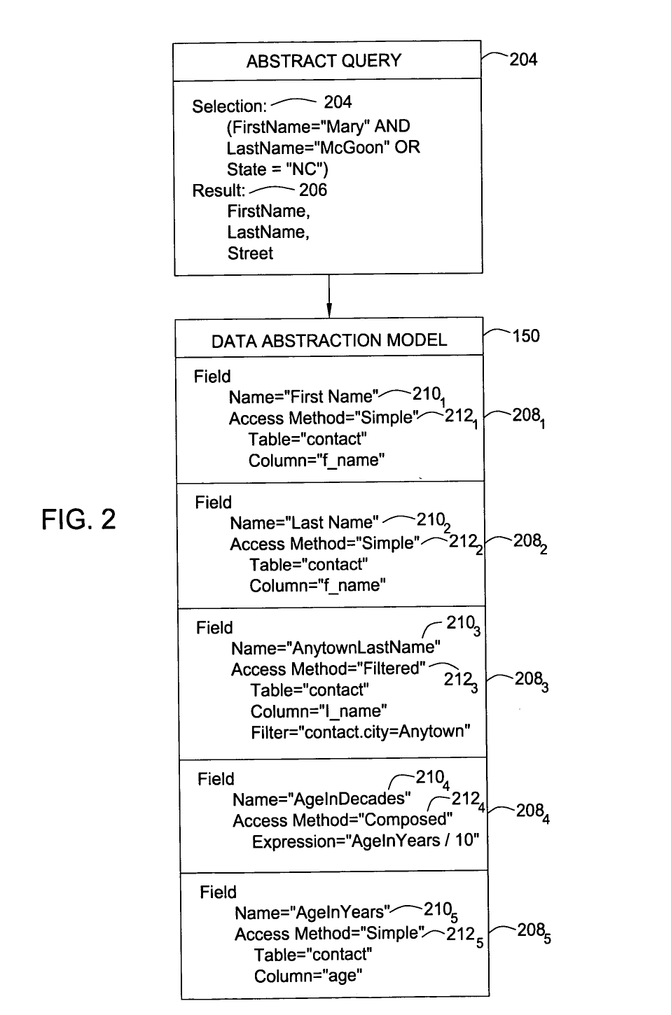

FIG. 2 illustrates one embodiment of a component of the data abstraction model 150 that comprises a plurality of logical field specifications 208₁₋₅ (five shown by way of example), collectively referred to as field specifications 208. Specifically, a field specification 208 is provided for each logical field 131 available for composition of an abstract query 130. Each field specification 208 identifies a logical field name 210₁, 210₂, 210₃, 210₄, 210₅ (collectively, field name 210) and references an associated access method 212₁, 212₂, 212₃, 212₄, 212₅ (collectively, access method 212). The access methods map a logical field to a particular physical data representation 214₁, 214₂ . . . 214_{N} in a database (e.g., one of the databases 156). By way of illustration, two data representations are shown, an XML data representation 214₁ and a relational data representation 214₂. However, the physical data representation 214_{N} indicates that any other data representation, known or unknown, is contemplated.

FIG. 2 also shows that the field specifications 208₁, 208₂ and 208₅ exemplify access methods 212₁, 212₂, and 212₅, respectively. For example, simple fields are mapped directly to a particular entity in the underlying physical data representation (e.g., a field mapped to a given database table and column). By way of illustration, the simple field access method 212₁ shown in FIG. 2 maps the logical field name 210₁ (“FirstName”) to a column named “f_name” in a table named “contact”. The field specification 208₃ exemplifies a filtered field access method 212₃. Filtered fields identify an associated physical entity and provide rules used to define a particular subset of items within the physical data representation. An example is provided in FIG. 2 in which the filtered field access method 212₃ maps the logical field name 210₃ (“AnytownLastName”) to a physical entity in a column named “I_name” in a table named “contact” and defines a filter for individuals in the city of Anytown. Another example of a filtered field is a New York ZIP code field that maps to the physical representation of ZIP codes and restricts the data only to those ZIP codes defined for the state of New York. The field specification 208₄ exemplifies a composed field access method 212₄. Composed access methods compute a logical field from one or more physical fields using an expression supplied as part of the access method definition. In this way, information which does not exist in the underlying data representation may be computed. In the example illustrated in FIG. 2 the composed field access method 212₃ maps the logical field name 210₃ “AgelnDecades” to “AgelnYears/10”. Another example is a sales tax field that is composed by multiplying a sales price field by a sales tax rate.

By way of example, the field specifications 208 of the component of the data abstraction model 150 shown in FIG. 1 are representative of logical fields mapped to data represented in the relational data representation 214₂. However, other instances of the data abstraction model 150 maps logical fields to other physical data representations, such as XML. An illustrative abstract query corresponding to an available abstract query 130 illustrated in FIG. 1 is shown in Table I below. Again, in this example, the data abstraction model 150 is defined using XML.

TABLE I
QUERY EXAMPLE

| 001 | <?xml version=“1.0”?> |
|---|---|
| 002 | <!--Query string representation: (FirstName = “Mary” |
| | AND LastName = |
| 003 | “McGoon”) OR State = “NC”--> |
| 004 | <QueryAbstraction> |

| | |
|---|---|
| 005 | <Selection> |

| | |
|---|---|
| 006 | <Condition internalID=“4”> |

| 007 | <Condition field=“FirstName” operator=“EQ” |
|---|---|
| | value=“Mary” |

| | |
|---|---|
| 008 | internalID=“1”/> |

| 009 | <Condition field=“LastName” operator=“EQ” |
|---|---|
| | value=“McGoon” |

| | |
|---|---|
| 010 | internalID=“3” relOperator=“AND”></Condition> |

| 011 | <Condition field=“State” operator=“EQ” value=“NC” |
|---|---|
| | internalID=“2” |

| | |
|---|---|
| 012 | relOperator=“OR”></Condition> |

| | |
|---|---|
| 013 | </Selection> |
| 014 | <Results> |

| | |
|---|---|
| 015 | <Field name=“FirstName”/> |
| 016 | <Field name=“LastName”/> |
| 017 | <Field name=“Street”/> |

| | |
|---|---|
| 018 | </Results> |

| | |
|---|---|
| 019 | </QueryAbstraction> |

The abstract query shown in Table I includes a selection specification (lines 005-015) containing selection criteria and a results specification (lines 016-020). In one embodiment, a selection criterion consists of a field name representing the logical field, a comparison operator (=, >, <, etc) and a value expression (what is the field being compared to). In one embodiment, result specification is a list of abstract fields that are to be returned as a result of query execution. A result specification in the abstract query may consist of a field name and sort criteria.

An illustrative instance of a component of the data abstraction model 150 (defined using XML) corresponding to the abstract query in Table I is shown in Table II below. For this example, the data abstraction model is defined using XML.

TABLE II
DATA REPOSITORY ABSTRACTION EXAMPLE

| | |
|---|---|
| 001 | <?xml version=“1.0”?> |
| 002 | <DataRepository> |

| | |
|---|---|
| 003 | <Category name=“Demographic”> |

| | |
|---|---|
| 004 | <Field queryable=“Yes” name=“FirstName” |

displayable=“Yes”>

| | |
|---|---|
| 005 | <AccessMethod> |

| | |
|---|---|
| 006 | <Simple columnName=“f_name” |

tableName=“contact”></Simple>

| | |
|---|---|
| 007 | </AccessMethod> |
| 008 | <Type baseType=“char”></Type> |

| | |
|---|---|
| 009 | </Field> |
| 010 | <Field queryable=“Yes” name=“LastName” |

displayable=“Yes”>

| | |
|---|---|
| 011 | <AccessMethod> |

| | |
|---|---|
| 012 | <Simple columnName=“l_name” |

tableName=“contact”></Simple>

| | |
|---|---|
| 013 | </AccessMethod> |
| 014 | <Type baseType=“char”></Type> |

| | |
|---|---|
| 015 | </Field> |
| 016 | <Field queryable=“Yes” name=“State” |

displayable=“Yes”>

| | |
|---|---|
| 017 | <AccessMethod> |

| | |
|---|---|
| 018 | <Simple columnName=“state” |

tableName=“contact”></Simple>

| | |
|---|---|
| 019 | </AccessMethod> |
| 020 | <Type baseType=“char”></Type> |

| | |
|---|---|
| 021 | </Field> |

| | |
|---|---|
| 022 | </Category> |

| | |
|---|---|
| 023 | </DataRepository> |

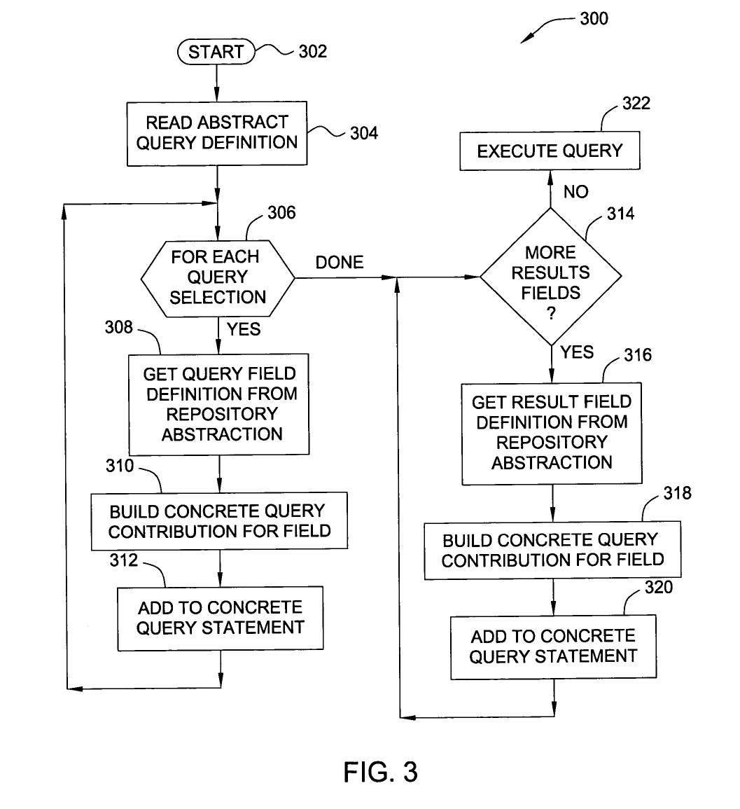

FIG. 3 shows an illustrative runtime method 300 exemplifying one embodiment of the operation of the query execution component 160. The method 300 processes an abstract query by mapping logical fields included in the abstract query to the underlying data using the access method specified for each query. Operations 300 begin at step 302 when the query execution component 160 receives as input an instance of an abstract query (such as the available abstract queries 130 shown in FIG. 1). At step 304, the query execution component 160 reads and parses the instance of the abstract query and locates individual selection criteria and desired result fields. At step 306, the query execution component 160 enters a loop (comprising steps 306, 308, 310 and 312) for processing each query selection criteria statement present in the abstract query, thereby building a data selection portion of a concrete query, also referred to herein as a physical query or executable query. In one embodiment, a selection criterion consists of a field name (for a logical field), a comparison operator (=, >, <, etc) and a value expression (what the field is being compared to).

At step 308, the query execution component 160 uses the field name from a selection criterion of the abstract query to look up the definition of the field in the data abstraction model 150. As noted above, the field definition includes a definition of the access method used to access the physical data associated with the field. The query execution component 160 then builds (step 310) a concrete query contribution for the logical field and conditional modifiers being processed. As defined herein, a concrete query contribution is a portion of a concrete query that is used to perform data selection based on the current logical field. A concrete query is a query represented in languages like SQL and XML Query and is consistent with the data of a given physical data repository (e.g., a relational database or XML repository). Accordingly, the concrete query is used to locate and retrieve data from a physical data repository, represented by the database 111 shown in FIG. 1. The concrete query contribution generated for the current field is then added to a concrete query statement. The method 300 then returns to step 306 to begin processing for the next field of the abstract query. Accordingly, the process entered at step 306 is iterated for each data selection field in the abstract query, thereby contributing additional content to the eventual query to be performed.

After building the data selection portion of the concrete query, the query execution component 160 identifies the information to be returned as a result of query execution. As described above, in one embodiment, the abstract query defines a list of logical fields that are to be returned as a result of query execution, referred to herein as a result specification. A result specification in the abstract query may consist of a field name and sort criteria. Accordingly, the method 300 enters a loop at step 314 (defined by steps 314, 316, 318 and 320) to add result field definitions to the concrete query being generated. At step 316, the query execution component 160 looks up a result field name (from the result specification of the abstract query) in the data abstraction model 150 and then retrieves a result field definition from the data abstraction model 150 to identify the physical location of data to be returned for the current logical result field. The query execution component 160 then builds (as step 318) a concrete query contribution (of the concrete query that identifies physical location of data to be returned) for the logical result field. At step 320, concrete query contribution is then added to the concrete query Statement.

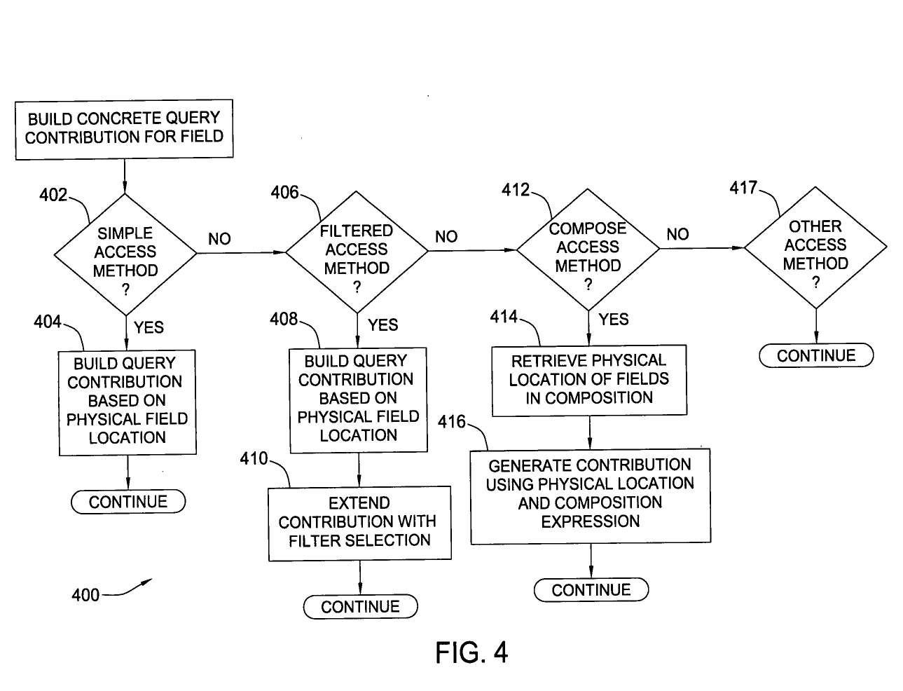

One embodiment of a method 400 for building a concrete query contribution for a logical field according to steps 310 and 318 is described with reference to FIG. 4. At step 402, the method 400 queries whether the access method associated with the current logical field is a simple access method. If so, the concrete query contribution is built (step 404) based on physical data location information (step 405). Processing then continues according to method 300 described above. Otherwise, processing continues to step 406 to query whether the access method associated with the current logical field is a filtered access method. If so, the concrete query contribution is built (step 408) based on physical data location information for some physical data entity. At step 410, the concrete query contribution is extended with additional logic (filter selection) used to subset data associated with the physical data entity. Processing then continues according to method 300 described above.

If the access method is not a filtered access method, processing proceeds from step 406 to step 412 where the method 400 queries whether the access method is a composed access method. If the access method is a composed access method, the physical data location for each sub-field reference in the composed field expression is located and retrieved at step 414. At step 416, the physical field location information of the composed field expression is substituted for the logical field references of the composed field expression, whereby the concrete query contribution is generated. Processing then continues according to method 300 described above.

If the access method is not a composed access method, processing proceeds from to step 417. Step 417 is representative of any other access method types contemplated as embodiments of the present invention. Those skilled in the art will recognize that embodiments are contemplated in which less then all the available access methods are implemented. For example, in a particular embodiment only simple access methods are used. In another embodiment, only simple access methods and filtered access methods are used.

It should be understood that the discussion above corresponding to FIG. 4 pertains to the building of a physical query based on an abstract query by processing each of the logical fields contained within the abstract query. According to one embodiment of the present invention two or more abstract queries 130 are combined using mathematical operations, referred to herein as query math; the result is a combined abstract query 161. In order to generate a physical query that corresponds to the combined abstract query 161, each field within the combined abstract query 161 is processed as described with reference to FIG. 4.

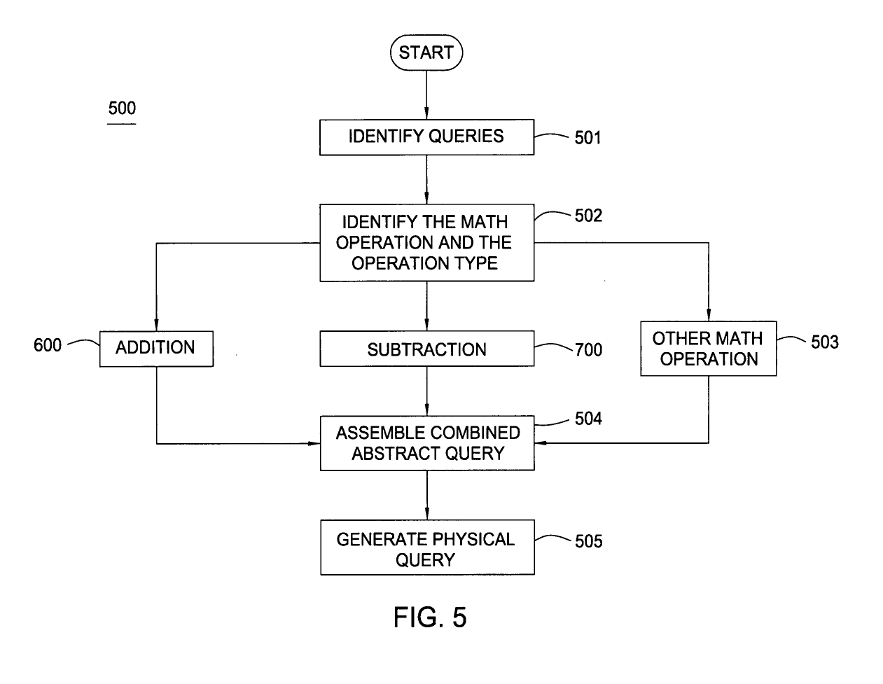

FIG. 5 describes processing related to query math, which begins at step 501 when queries that are to be combined with a math operation are identified. At step 502, attributes of the particular math operation are determined. For one embodiment, the math operations supported are addition and subtraction. The “type” of math operation is also determined at step 502.

For one embodiment, three types of operations are supported: output, condition and all. When “type=output” is specified, only the output fields are added or subtracted according to the math operation. Output fields of an abstract query are columns in the SELECT clause portion of the corresponding physical query. Similarly, when “type=condition” is specified, only the condition fields are added or subtracted according to the math operation. Condition fields of an abstract query are columns in the WHERE clause portion of the corresponding physical query. Finally, when “type=all” is specified, both the output fields and the condition fields are added or subtracted.

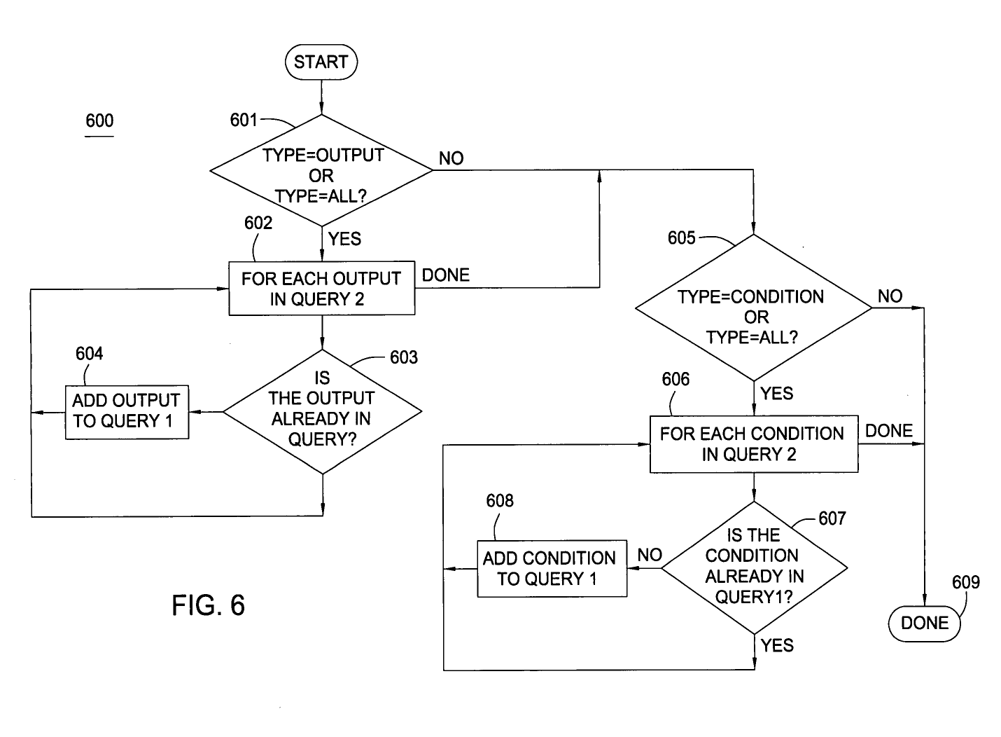

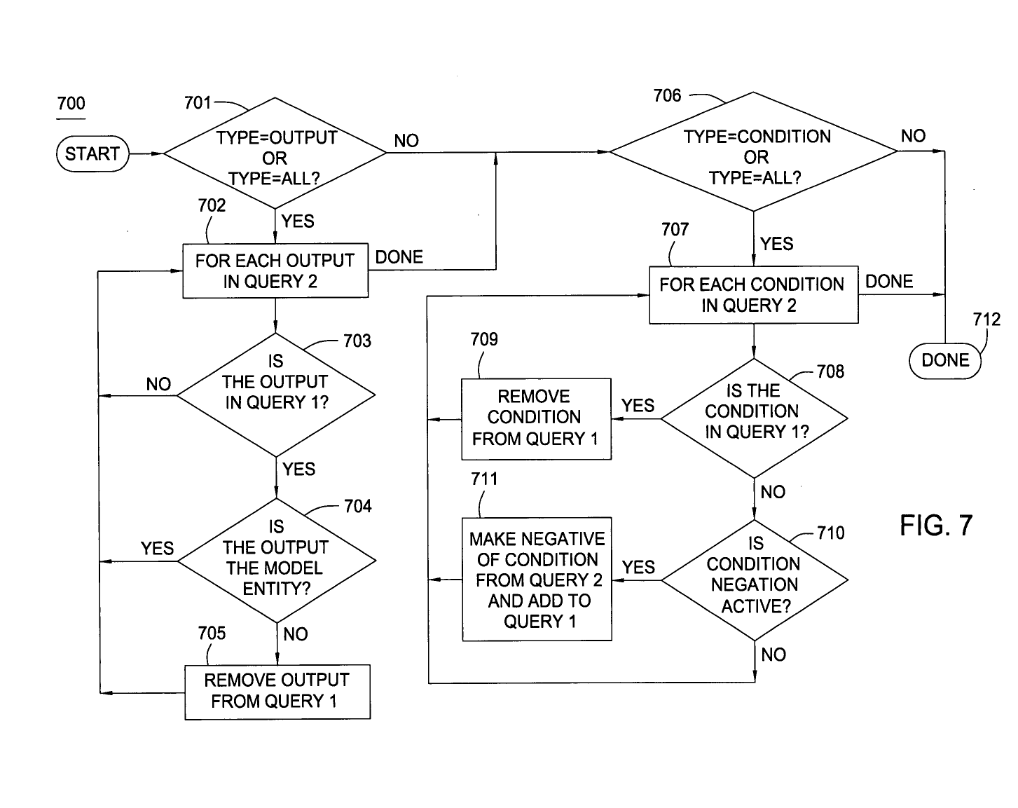

If the math operation selected at step 502 is addition, operations 600, described with reference to FIG. 6 are executed. Alternatively, if subtraction is selected, operations 700, described with reference to FIG. 7, are executed. For some embodiments, other math operations, including variations of addition and subtraction, may be processed according to other operations 503. Next, the combined abstract query 161 is assembled at step 504. Finally, at step 505, a physical query corresponding to the combined abstract query 161 is generated. The process of generating physical queries based on abstract queries is described in detail in the previously referenced U.S. patent application Ser. No. 10/083,075.

The examples provided herein utilize and demonstrate the combination of only two queries for purposes of brevity and clarity. However, it should be noted that embodiments of the present invention can accommodate query math operations that are used to combine more than two abstract queries concurrently applying these same concepts. In some cases, such as query math operations involving non-commutative subtraction, the order of the queries involved may need to be specified to obtain a desired result.

Referring now FIG. 6, operations 600 are provided. Operations 600 pertain to the “addition” of two abstract queries (Q1+Q2) and creating a combined abstract query using an addition based query math operation. Stated another way, operations 600 specify the addition of one available abstract query (Q2) to another available abstract query (Q1).

At step 601, the type of query math operation to be performed is determined. If the type of addition operation is “output” or “all”, processing continues to step 602. Otherwise, processing skips to step 605. At step 602, all the output fields in Q2 are identified. At step 603, for each output field identified in Q2, it is determined whether the particular output field already exists in Q1. If the output field is already included in Q1, then processing skips to step 604 for the next output field in Q2. However, if the output field does not already exist in Q1, it is added to Q1 at step 604.

At step 605, it is determined if the addition operation is of the type “condition” or “all”. If the type is neither of these, the process is exited at step 609. However, if the current operation is of type “condition” or “all”, processing proceeds to step 606. At step 606, condition fields in Q2 are identified. It should be noted that if the current operation's type is “all”, by this point, all the output fields have already been processed in steps 602-604.

For each condition field in Q2, at step 607 it is determined if the present condition field is already included in Q1. If the condition is not already in Q1, it is added during step 608. Next, processing returns to step 606 to process the remaining condition fields. Once all the condition fields of Q2 have been processed, operations 600 are exited at step 609.

It should be noted that while the example above is described with reference to Q2 being added to Q1 (i.e., Q1+Q2), due to the commutative nature of addition, the combined query would have been exactly the same if Q1 were being added to Q2 (i.e., Q2+Q1). This would not be the case with subtraction based query math operations, however, because subtraction is not commutative.

FIG. 7 illustrates operations 700 for creating a combined abstract query by subtracting one query from another. Specifically, the abstract query, Q2, is being subtracted from Q1 (i.e., Q1−Q2). At step 701, it is determined if the operation type is “output” or “all”. Similar to the addition operation described earlier, if the operation type is “output”, only the output fields are involved in the subtraction operation. While only the condition fields are involved in the subtraction operation if the type is “condition”, and both output fields and condition fields are included in the subtraction operation if the type is “all”.

If the operation type is “output” or “all”, at step 702 all the output fields in Q2 are identified. Next, at step 703, for each identified field, it is determined if the current output field from Q2 exists in Q1. If the field does not exist in Q1, processing returns to step 702 for the next field. However, if the current field does exist, at step 704 it is determined if the present output field is a model entity. As used herein, the term “model entity” generally represents the core subject of an abstract query. For instance, if a particular query is related to patients or patients' attributes, “patient” is the model entity of the query. It should be noted that during subtraction operations, the model entity will not get subtracted out. In fact, regardless of query math operation and type, the model entity will always be an output field included in the result set. Model entities are described in more detail in the commonly owned, co-pending application Ser. No. 10/403,356, entitled “Dealing With Composite Data Through Data Model Entities”, herein incorporated by reference in its entirety.

Referring back to step 704, if the present field is the model entity, then the field remains in Q1 and processing returns to step 702. Otherwise, processing proceeds to step 705 and the present output field is removed from Q1. At step 706, it is determined if the type of the current subtraction operation is “condition” or “all”. If the operation type is neither of those, the process is exited at step 712.

However, if the operation type is “condition” or “all”, processing continues to step 707. At step 707, each condition field from Q2 is identified. At step 708 it is determined if the current condition field is included as a condition field in Q1. If it is included in Q1, at step 709 the current condition field is removed from Q1 and processing returns to step 708 for the next condition field in Q2.

If the current condition field is not in Q1, at step 711 it is determined if “condition negation” is active for the current operation. Condition negation functionality can only be used with the subtraction query operation to include an expression containing a condition field with a negated value in the combined query. For instance, suppose that a query, Q4 is being subtracted from another query Q3 (i.e., Q3−Q4), and condition negation is activated. Further suppose that a field called “City” that is assigned the value “Rochester” is in one of the condition fields included in Q4. If Q3 does not have “City” field as one of its condition fields, then the “City” field and the negative of its value, “!=Rochester” in this case, will be included in the combined query. In other words, the following expression containing the “City” condition field will be included in the combined query: “City !=Rochester”.

Referring now to step 711, if condition negation is active, an expression containing the condition field representing the negative of the expression containing the current condition field from Q2 is created and then added to Q1. Processing returns to step 708 for the next condition in Q2. Once processing is completed for each condition in Q2, the process 700 is exited at step 712.

In order to describe query math operations further, examples of such operations and the corresponding abstract query syntax are provided below in Tables A, B, C and D. Table A lists an example where two abstract queries, Q1 and Q2, are added with operation type of “all”. Table B illustrates an addition operation with type “output” for the queries Q1 and Q2 from Table A. Table C lists a subtraction based query math operation with type of “all”, and Table D provides a subtraction operation which includes condition negation.

TABLE A
ADDITION EXAMPLE

First Abstract Query (Q1):

| | | |
|---|---|---|
| 001 | Output: | Patient ID, Diagnosis, Diagnosis Date |
| 002 | Conditions: | Diagnosis = X AND Address.State = Minnesota |

Second Abstract Query (Q2):

| | | |
|---|---|---|
| 003 | Output: | Patient ID, Test, Test Date |
| 004 | Conditions: | Test = A OR Test = B OR Test = C |

Combined Abstract Query, Q1 + Q2, Type = All:

| | | |
|---|---|---|
| 005 | Output: | Patient ID, Diagnosis, Diagnosis Date, |
| 006 | | Test, Test Date |
| 007 | Conditions: | Diagnosis = X AND |
| 008 | | (Test = A OR Test = B OR Test = C) AND |
| 009 | | Address.State = Minnesota |

Lines 001 and 002 of Table A, shown above, list abstract query syntax corresponding to the first abstract query, Q1 and lines 003 and 004 list the abstract query syntax for the second abstract query, Q2. Q1 specifies that a patient's ID number (i.e., a unique identification number that is assigned to each patient), name of the test taken and the date of the test be returned for each instance under the conditions that diagnosis=“X” and the state in which the patient lives is Minnesota. Similarly, lines 003 and 004 show the syntax related to Q2, which specifies that a patient's ID number, the name of the test taken and the date of the test be returned under the conditions that the test taken is one of: A, B or C.

Lines 005-009 of Table A, list the syntax of a combined query composed by utilizing the query math process method to add Q1 and Q2 together. For this example, the “all” operation type was chosen. Accordingly, it can be seen that the combined query includes all the output fields from Q1 and Q2, and also all the condition fields from Q1 and Q2. It should be noted that fields that are included in both Q1 and Q2, such as Patient ID, are listed only once in the combined query—this is to avoid listing a particular field and its values twice.

Simpler examples of the addition operation could include the addition of only the output fields, or of the addition of only the condition fields. For instance, suppose that for the addition operation of Table A, the type specified is “output” rather than “all”. Accordingly, the syntax of the combined query would be as listed below in Table B. The syntax shows that all the output fields from Q1 and Q2 are included in the combined query, but only the conditions from Q1 are included.

TABLE B
ANOTHER ADDTITION EXAMPLE
Combined Abstract Query, Q1 + Q2, Type = Output:

| | | |
|---|---|---|
| 001 | Output: | Patient ID, Diagnosis, Diagnosis Date, |
| 002 | | Test, Test Date |
| 003 | Conditions: | Diagnosis = X AND Address.State = Minnesota |

Table C, shown below, provides an example of a subtraction operation involving abstract queries, Q1 and Q2.

TABLE C
SUBTRACTION EXAMPLE

| First Abstract Query (Q1): | | |
|---|---|---|
| 001 | Output: | Patient ID, Diagnosis, Diagnosis Date |
| 002 | Conditions: | Diagnosis = X OR Diagnosis = Y AND |
| 003 | | Address.State = Minnesota |
| Second Abstract Query (Q2): | | |
| 004 | Output: | Patient ID, Diagnosis, Diagnosis Date |
| 005 | Conditions: | Diagnosis = X OR Diagnosis = Y |
| Combined Abstract Query, Q1 − Q2, Type = All: | | |
| 006 | Output: | Patient ID |
| 007 | Conditions: | Address.State = Minnesota |

As with the example of Table A, the type of operation is set to “all”. Lines 001-003 of Table C lists syntax associated with Q1, which specifies that a patient's ID, diagnosis and diagnosis date be returned under conditions that the diagnosis=“X” or that the diagnosis=“Y”. Additionally, Q1 specifies that patient's state of residence should be Minnesota. Q2 also specifies the patient's ID, diagnosis and diagnosis date as the output fields. In terms of conditions, Q2 specifies that the diagnosis=“X” or “Y”.

The combined abstract query corresponding to Q1−Q2 from Table C is shown in lines 006 and 007. The combined abstract query specifies that a patient's ID be returned under the condition that the state of residence is Minnesota. It can be seen that output fields diagnosis and diagnosis date were subtracted out.

However, patient ID remained because it is the model entity of Q1. Condition fields related to diagnosis=“X” or “Y” were also subtracted out.

Table D, shown below, lists two queries that are very similar to the exemplary queries described above. Q1 is listed on lines 001-003, Q2 is listed on lines 004-006, and the combined abstract query is listed on lines 007-009. The subtraction of Q2 from Q1 is performed in the same manner as described above with reference to Table C. The only difference is related to condition negation. The Q2 condition requiring City=“Rochester” is not included in Q1. Accordingly, because condition negation is utilized, in the combined query (lines 007-009) it can be seen that a negated version of this expression is included on line 009. Specifically, the negated expression specifies that patients from Rochester be filtered out from the result set.

TABLE D
SUBTRACTON EXAMPLE WITH CONDITION NEGATION

| First Abstract Query (Q1): | | |
|---|---|---|
| 001 | Output: | Patient ID, Diagnosis, Diagnosis Date |
| 002 | Conditions: | Diagnosis = X OR Diagnosis = Y AND |
| 003 | | Address.State = Minnesota |
| Second Abstract Query (Q2): | | |
| 004 | Output: | Patient ID, Diagnosis, Diagnosis Date |
| 005 | Conditions: | Diagnosis = X OR Diagnosis = Y AND |
| 006 | | Address.City = Rochester |
| Combined Abstract Query, | | |
| Q1 − Q2, Type = All, Condition Negation = Active: | | |
| 007 | Output: | Patient ID |
| 008 | Conditions: | Address.State = Minnesota AND |
| 009 | | Address.City != Rochester |

While the exemplary abstract queries presented above in Tables A, B, C and D are relatively simple, those skilled in the art will understand that more complex abstract queries can be accommodated by embodiments of the present invention.

### An Exemplary Graphical User Interface

FIGS. 8 and 9 are exemplary graphical user interface (GUI) screens provided via a query builder interface and configured to allow users (e.g., data architects or administrators) to combine queries using query math.

FIG. 8 illustrates a screen that might be presented via a query building interface 120 during a query building session where an abstract query is being constructed using query math by combining previously defined abstract queries together. A collection of icons representing available abstract queries are provided on the left side of the screen. For this particular example, Query 1 and Query 2 are dragged onto the pallet 812, or workspace. As they are dropped onto the pallet 812, the syntax (in abstract form) corresponding to Query 1 and Query 2 is shown in windows 802 and 804 respectively.

A drop down box 805 is presented to allow the user to pick a particular query math operation, such as addition or subtraction, represented by “+” or “−” respectively. A second drop down box 806 is presented to allow the user to pick the type (e.g., output, condition or all) for the current operation. For instance, if the operation is directed only to output fields, the type “Output” is selected.

Based on the query math operation and type of operation chosen, and of the queries that have been selected, the syntax of the corresponding combined query is presented in a separate window 807. If the user is satisfied with the current selections, the Continue button 810 can be pushed to continue processing and generate a physical query according to the combined abstract query. However, if the user desires to change settings or to revert to a previous screen, the Cancel 811 button can be pushed to exit the current screen without saving changes.

While the example illustrated in FIG. 8 was based on adding two queries together, the example illustrated in FIG. 9 is based on subtracting one query from another. The operation type selected is “All” and condition negation is activated. Query 3 and Query 4 (901 and 902, respectively) are selected by being dragged onto the pallet 812. Next, the subtraction operation is selected with drop down box 805, and type “All” is selected with box 806. Condition negation is activated for this operation by selecting check box 908.

Windows 902 and 904 present the syntax of Q3 and Q4, respectively. The syntax representing the combined query is presented in a separate window 905. It can be seen in the combined abstract query syntax that only Patient ID remains as an output field 906 in the combined query. This is because Patient ID is the model entity for this query. The conditions portion 907 of the combined query shows that the condition “Diagnosis=X” has been eliminated in accordance to the subtraction operation. Further, due to condition negation being activated, and the fact that a condition based on city did not exist in Q3, the expression “City !=Rochester”.

While the examples above include only two abstract queries being combined to form a third abstract query, it should be understood that embodiments of the current invention can be used to combine numerous (more than two) abstract queries together. Further, while the examples above are based on only three types of addition and subtraction operations (e.g., output, conditions, all), those skilled in the art will recognize that embodiments of the current invention can be configured with a variety of other types that provide additional functionality.

While the foregoing is directed to embodiments of the present invention, other and further embodiments of the present invention may be devised without departing from the basic scope thereof, and the scope thereof is determined by the claims that follow.

What is claimed is:

1. A computer-implemented method for querying data comprising:
providing a first query and a second query;
receiving a selection of a mathematical operator selected from one of (i) an addition operator configured to perform addition of the first and second queries; and (ii) a subtraction operator configured to perform subtraction of the first and second queries; and
operating on the first and second queries according to the selected mathematical operator to generate a resultant query, wherein operating comprises one of:
adding selected fields of the first and second queries to the resultant query if the selected mathematical operator is the addition operator; and
omitting selected fields of the first and second queries from the resultant query if the selected mathematical operator is the subtraction operator.

2. The computer-implemented method of claim 1, wherein the first and second queries are combined in mathematical operations that are of specific operation types, wherein the operation types are one of: a first operation type specifying that only output fields are operated on; a second operation type specifying that only condition fields are operated on, and a third operation type specifying that both output fields and condition fields are operated on.

3. The computer-implemented method of claim 1, wherein the selected fields from the first query and second query can be defined with data types that are one of: number, character and date.

4. A computer-implemented method for querying data, comprising:
providing a first query and a second query, wherein the first and second queries are abstract queries defined according to logical fields having respective definitions in a data abstraction model, wherein each respective definition comprises a field name, a location of a counterpart physical field and a reference to an access method configured to access the physical field;
receiving a selection of a mathematical operator selected from one of (i) an addition operator configured to perform addition of the queries; and (ii) a subtraction operator configured to perform subtraction of the queries; and
operating on the first and second queries according to the selected mathematical operator to generate a resultant query, wherein operating comprises one of:
adding selected fields of the first and second queries to the resultant query if the selected mathematical operator is the addition operator; and
omitting selected fields of the first and second queries from the resultant query if the selected mathematical operator is the subtraction operator.

5. The computer-implemented method of claim 4, wherein the first and second queries are combined in mathematical operations that are of specific operation types, wherein the operation types are one of: a first operation type specifying that only output fields are operated on, a second operation type specifying that only condition fields are operated on, and a third operation type specifying that both output fields and condition fields are operated on.

6. The computer-implemented method of claim 4, wherein the selected fields from the first query and second query can be defined with data types that are one of: number, character and date.

7. A computer-implemented method of mathematically operating on queries in a graphical user interface environment, comprising providing a graphical interface comprising:
a query list for displaying representations of a plurality of queries;
a first window for displaying a syntax of a first query selected from the query list;
a second window for displaying a syntax of a second query selected from the query list;
an operator selection element allowing selection of a mathematical operator from at least two available mathematical operators for mathematically relating at least two queries selected from the query list, wherein the at least two available mathematical operators comprise an addition operator and a subtraction operator; and
a button for initiating a process of mathematically operating on the first and second queries according to the selected mathematical operator to produce a resultant query, wherein the process comprises:
adding selected fields of the first and second queries to the resultant query if the selected mathematical operator is the addition operator; and
omitting selected fields of the first and second queries from the resultant query if the selected mathematical operator is the subtraction operator.

8. The computer-implemented method of claim 7, further comprising a pallete to which representations of queries are dragged from the query list, thereby causing the respective dragged queries to be displayed in the first and second windows.

9. The computer-implemented method of claim 7, wherein the first and second queries are abstract queries defined according to logical fields having respective definitions in a data abstraction model, wherein each respective definition comprises a field name, a location of a counterpart physical field and a reference to an access method configured to access the physical field.

10. The computer-implemented method of claim 7, wherein the first and second queries are combined in mathematical operations that are of specific operation types, wherein the operation types are one of: a first operation type specifying that only output fields are operated on, a second operation type specifying that only condition fields are operated on, and a third operation type specifying that both output fields and condition fields are operated on.

11. The computer-implemented method of claim 10, wherein the first and second queries comprise output fields specifying fields to be returned upon execution of the query and condition fields used in defining one or more conditions of the respective queries and wherein operating comprises adding only output fields if the selected mathematical operator is the addition operator and the operation type is the first operation type.

12. The computer-implemented method of claim 10, wherein the operating comprises adding output fields to one another and adding condition fields to one another if the selected mathematical operator is the addition operator and the operation type is the third operation type.

13. A computer-implemented method for querying data comprising:
providing a first query and a second query, wherein the first and second queries are abstract queries defined according to logical fields having respective definitions in a data abstraction model, wherein each respective definition comprises a field name, a location of a counterpart physical field and a reference to an access method configured to access the physical field;
receiving a selection of a an operation type, wherein the operation type is one of: a first operation type specifying that only output fields are operated on, a second operation type specifying that only condition fields are operated on, and a third operation type specifying that both output fields and condition fields are operated on;
if the first operation type is selected, for each output field in the second abstract query:
determining whether that output field exists in the first abstract query;
if so, removing that output field from the first abstract query;
if the second operation type is selected, for each field in the conditional portion of the second abstract query:
determining whether the field exists in the conditional portion of the first abstract query;
if so, removing the field from the first abstract query; and
if the field does not exist in the conditional portion of the first abstract query: adding the field to the conditional portion of the first abstract query, with the negative of its original value.

14. A computer-readable medium containing a program which, when executed, performs operations for combining abstract queries from within an application comprising:
providing a first query and a second query;
receiving a selection of a mathematical operator selected from one of (i) an addition operator configured to perform addition of the queries; and (ii) a subtraction operator configured to perform subtraction of the queries; and
operating on the first and second queries according to the selected mathematical operator to generate a resultant query, wherein operating comprises one of:
adding selected fields of the first and second queries to the resultant query if the selected mathematical operator is the addition operator; and
omitting selected fields of the first and second queries from the resultant query if the selected mathematical operator is the subtraction operator.

15. The computer-readable medium of claim 14, wherein the first and second queries are combined in mathematical operations that are of specific operation types, wherein the operation types are one of: a first operation type specifying that only output fields are operated on, a second operation type specifying that only condition fields are operated on, and a third operation type specifying that both output fields and condition fields are operated on.

16. The computer-readable medium of claim 15, wherein the selected fields from the first query and second query can be defined with data types that are one of: number, character and date.

17. A computer-readable medium containing a program which, when executed, performs operations for combining abstract queries from within an application comprising:
providing a first query and a second query, wherein the first and second queries are abstract queries defined according to logical fields having respective definitions in a data abstraction model, wherein each respective definition comprises a field name, a location of a counterpart physical field and a reference to an access method configured to access the physical field;
receiving a selection of a an operation type, wherein the operation type is one of: a first operation type specifying that only output fields are operated on, a second operation type specifying that only condition fields are operated on, and a third operation type specifying that both output fields and condition fields are operated on;
if the first operation type is selected, for each output field in the second abstract query:
determining whether that output field exists in the first abstract query;
if so, removing that output field from the first abstract query;
if the second operation type is selected, for each field in the conditional portion of the second abstract query:
determining whether the field exists in the conditional portion of the first abstract query;
if so, the field is removed from the first abstract query; and
if the field does not exist in the conditional portion of the first abstract query: adding the field to the conditional portion of the first abstract query, with the negative of its original value.

18. The computer-readable medium of 17, wherein the first operation type specifies that only output fields are operated on, the second operation type specifies that only condition fields are operated on, and the third operation type specifies that both output fields and condition fields are operated on.

19. The computer-readable medium of claim 18, wherein the selected fields from the first query and second query can be defined with data types that are one of: number, character and date.

20. A computer-readable medium containing a program configured for combining abstract queries from within an application comprising, in a graphical user interface environment, comprising: providing a graphical interface comprising:
a query list for displaying representations of a plurality of queries;
a first window for displaying a syntax of a first query selected from the query list;
a second window for displaying a syntax of a second query selected from the query list;
an operator selection element displayed on the pallete and allowing selection of a mathematical operator from at least two available mathematical operators for mathematically relating at least two queries selected from the query list, wherein the at least two available mathematical operators comprise an addition operator and a subtraction operator; and
a button for initiating a process of mathematically operating on the first and second queries according to the selected mathematical operator to produce a resultant query, wherein the process comprises:
adding selected fields of the first and second queries to the resultant query if the selected mathematical operator is the addition operator; and
omitting selected fields of the first and second queries from the resultant query if the selected mathematical operator is the subtraction operator.

21. The computer-readable medium of claim 20, further comprising a pallete to which representations of queries are dragged from the query list, thereby causing the respective dragged queries to be displayed in the first and second windows.

22. The computer-readable medium of claim 20, wherein the first and second queries are abstract queries defined according to logical fields having respective definitions in a data abstraction model, wherein each respective definition comprises a field name, a location of a counterpart physical field and a reference to an access method configured to access the physical field.
